(19) United States
(12) Patent Application Publication
(10) Pub. No.: US 2002/0135185 A1
(43) Pub. Date: Sep. 26, 2002

(54) Energy system for electric vehicle

(76) Inventor: Mykhaijlo Pavlykivskyj, Chicago, IL (US)

Correspondence Address: Andrew G Kolomayets, Cook Alex McFarron Manzo Cummings & Mehler, 200 West Adams Street Suite 2850, Chicago, IL, 60606, US

(21) Appl. No.: 09/890,474

(22) PCT Filed: Feb. 1, 2001
(86) PCT No.: PCT/US01/03366

(51) Int. Cl. H02P 9/04

(52) U.S. Cl. 290/1 R

(57) ABSTRACT

An energy providing system (12) for an electric vehicle (10) is described. The system includes a rotor (22) mounted on a generator (20). The system (12) is attached to the interior of the vehicle body and is maintained in a substantially horizontal position even when the vehicle (10) travels over uneven surfaces.

### CROSS-REFERENCE TO RELATED APPLICATION

This application claims the benefit of U.S. Provisional Patent Application Serial No. 60/179,944, filed Feb. 3, 2000.

### FIELD OF INVENTION

The present invention relates generally to electric vehicles and energy or energy-providing systems for such vehicles. More specifically, the present invention relates to a system for providing energy to the vehicle in a way that preserves and extends the life of the battery. Finally, the present invention relates to an electric vehicle and to the placement of the energy-providing system, such as a generator and associated components within the electric vehicle.

### BACKGROUND OF THE INVENTION

Concerns about air pollution emitted by gasoline powered automobiles, the cost of fuel, and noise pollution have led to a great interest in the area of alternative means for powering vehicles such as automobiles. Of particular interest are vehicles that are powered in whole or in part by electrical energy. These vehicles are typically powered by the electrical energy provided by a battery.

One of the drawbacks of electrically powered vehicles, however, is the capacity of the batteries to adequately power the vehicles. The frequent need to recharge batteries and/or replace batteries has made the development and manufacture of electrically powered vehicles commercially non-viable.

Accordingly, it would be desirable to provide an electric vehicle that can travel relatively longer distances with less frequent replacement and/or recharging of the batteries. Moreover, it would be desirable to provide an electric vehicle wherein the life of the batteries can be preserved.

### SUMMARY OF THE INVENTION

The present invention addresses all of the above described problems with the existing electrical vehicles.

In one aspect, the present invention is directed to an energy-providing system for an electric vehicle that includes a generator for providing electrical energy, a rotor coupled to the generator and a starter motor for initiating rotation of the rotor. The rotor is rotatably mounted on the generator.

In another aspect, the rotor includes mobile weights housed within cavities of the rotor. In another aspect of the present invention, at least the generator and rotor may be attached to the interior body of the car. The rotor and generator remain stable and in a substantially horizontal position, even when the vehicle travels over uneven surfaces.

Thus, in another aspect, the present invention is directed to an energy providing system that includes means for maintaining the rotor and generator in a substantially horizontal position. In one aspect, the means for maintaining the rotor and generator in a stable, substantially horizontal position includes a double bearing assembly attached to the interior of the vehicle body and to a framework attached to the generator.

### BRIEF DESCRIPTION OF THE DRAWINGS

FIG. 1 is a side view of an electrical vehicle embodying an energy-providing system of the present invention in association with other components;

FIG. 2 is a front view of an electrical vehicle embodying the energy providing system of the present invention;

FIG. 3 is a perspective view of the energy providing system of the present invention;

FIG. 3A is a partial, enlarged view of the energy-providing system of the present invention;

FIG. 4 is a cross-sectional view of the top portion of the rotor of the energy-providing system of the present invention;

FIG. 5 is a plan view from the bottom of the top portion of the rotor of the present invention;

FIG. 6 is a plan view of the bottom portion or base plate of the rotor of the present invention.

FIG. 7A is a front view of a mobile weight used with the rotor of the present invention;

FIG. 7B is a side view of the moving weight of FIG. 7A;

FIG. 8 is a partial, cross-sectional view of the double bearing assembly of the energy-providing system of the present invention; and

FIG. 9 is a partial, cross-sectional view of the columnar member of the energy-providing system of the present invention.

### DETAILED DESCRIPTION OF THE DRAWINGS

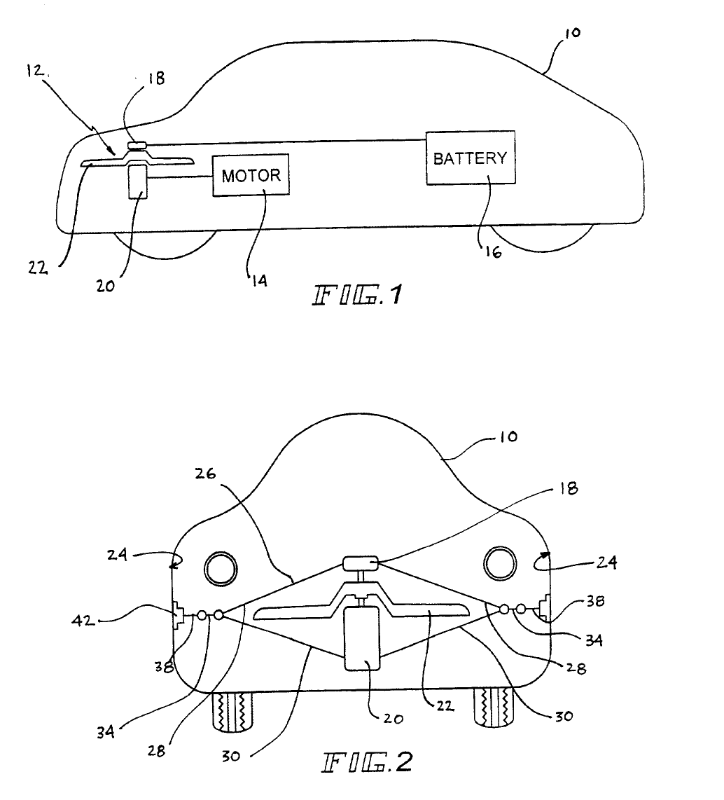

Turning now to the figures, FIG. 1 shows a vehicle 10 including the energy providing system of the present invention. As shown in FIG. 1, vehicle 10 includes the energy providing system 12, preferably located in the front portion of the vehicle. The energy providing system 12 is electrically coupled to a motor 14, which powers the drive train of the vehicle. A battery 16 may be located near the rear of the vehicle and provides electrical energy to the starter motor 18 of the system 12.

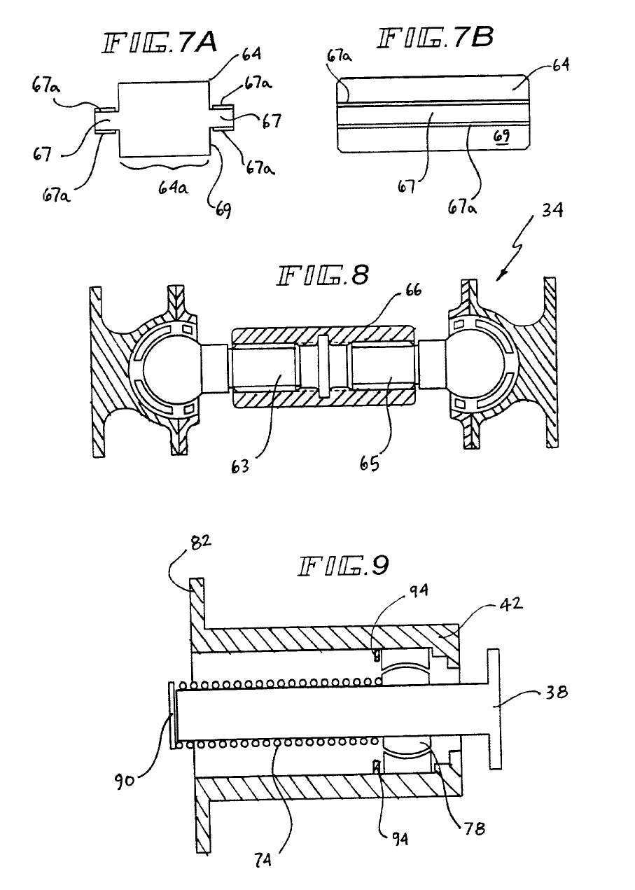

As shown in FIGS. 1 and 2, the energy providing system 12 is typically located within the body of the vehicle where, in a gasoline powered vehicle, the internal combustion engine would have been. System 12 may include, in general, a generator 20 and a rotor 22 rotatably mounted to generator 20 via wrapping flange or sleeve 19. A starter motor 18 may also be located near the rotor 22. It is preferred that starter motor 18 be placed in a horizontal position and that the entire cluster of rotor, generator, starter motor be balanced. The generator, rotor and electrical starter motor 18 are attached to the body interior 24 of the vehicle 10 by a framework 26, as shown generally in FIG. 2. The center of gravity of the cluster of the generator 20, rotor 22 and motor should be lower than the horizontal line of the arms 28 and 30 of the supporting framework. The arms 28 and 30 of the framework 26 are attached to one end of the double bearing assembly 34, shown generally in FIG. 2, and in more detail in FIG. 8. The other end of the double bearing assembly is attached to a moveable shaft 38. As described in more detail below, shaft 38 is attached to and moveable within a columnar member 42. Member 42 is, in turn, attached to the interior of vehicle body 24.

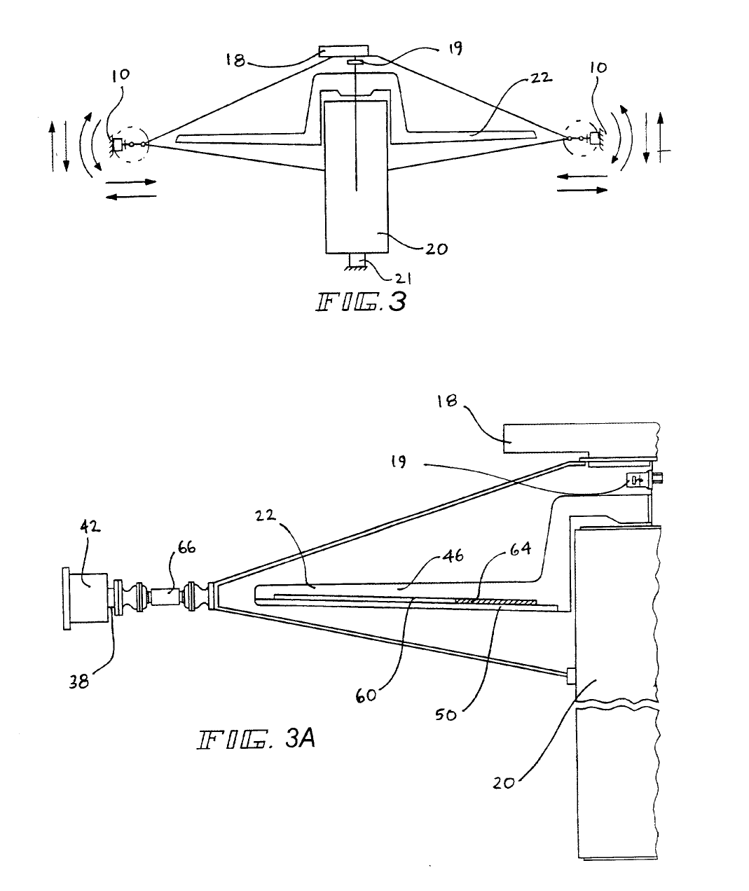

A more detailed view of the energy providing system 12 of the present invention is shown in FIG. 3. As shown in FIG. 3, generator 20 may be attached by resilient mount 21 to the floor of vehicle 10. Rotor 22 is rotatably mounted on the generator 18. Rotor 22 is attached to the interior rotating portion of generator 20. Rotation or rotor 22 thereby causes rotation of the interior components of generator 20 to produce an electrical current, as will be understood by those of skill in the art.

Starter motor 18 may also be coupled to rotor 22 by wrapping flange or sleeve 19. Starter motor 18 provides the impulse power or energy to initiate rotation of rotor 22. The energy may be provided by battery 16, as shown in FIG. 1.

The principal part of the rotor 22 is shown in FIGS. 3A and 4. As shown in FIG. 4, rotor 22 (or flywheel) includes a top portion 46 and a second bottom portion or base plate 50. The top and bottom portions 46 and 50 may be attached by any known means, such as bolts or screws. Top portion 46 of rotor 22 includes a depending lip 47, as shown in FIG. 4, and is relieved to receive bottom plate 50. Accordingly, when the two portions of rotor are brought together, the peripheral portion of base plate 59 is attached to depending lip 47 and the interior portion of the base plate is fitted into and attached to relieved portion 48 of rotor top portion 46. When brought together, the two portions provide gaps or raceways 60 to facilitate movement of mobile weights 64, as described in more detail below. It is preferred that the surfaces of the top and bottom portions that define raceways 60 have a minimal roughness and, more preferably, that they be polished.

The rotor may be made of iron, steel or any other suitable metal. The diameter “d” will depend on the diameter of the generator and the depth “h” will depend upon the length of the generator. Preferably, depth “h” is approximately ⅓ of the length of the generator. The diameter “D” may be any size, but will, of course, depend on the size of the vehicle.

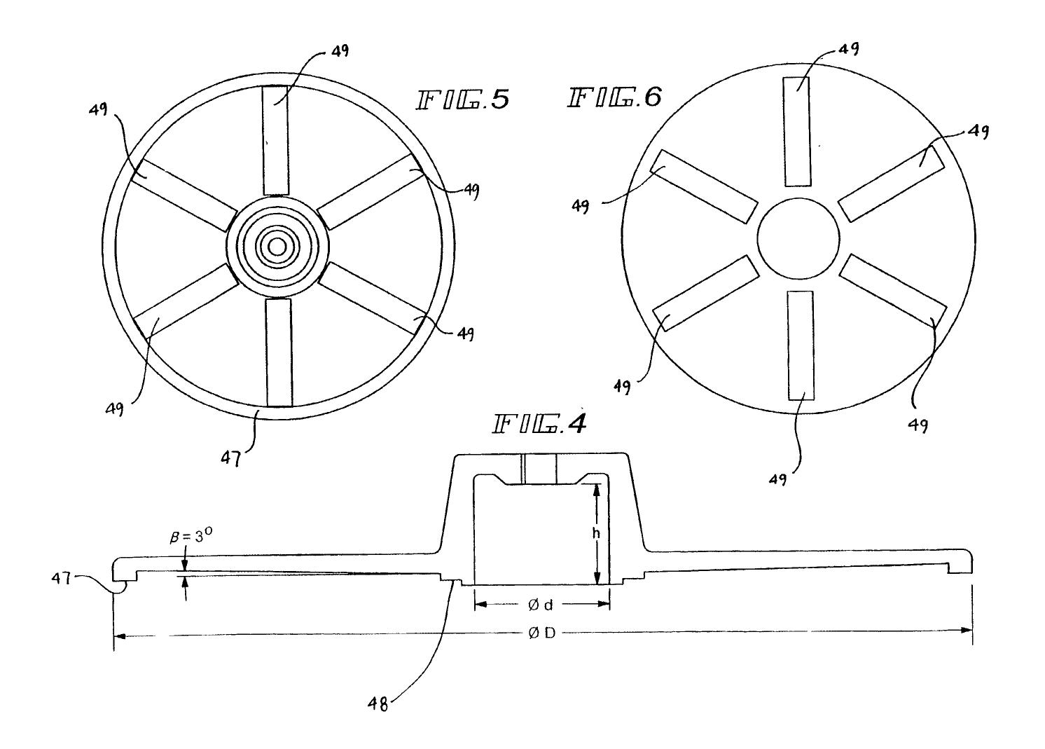

Top portion 46 and bottom portion 50 also define slots or cavities in the rotor. As shown in FIGS. 5 and 6, cavities are radially spaced on rotor 22 (like spokes on a wheel). In the preferred embodiment, the rotor may include six (6) generally rectangular cavities 49 to receive the mobile weights. Of course, rotor 22 may have more or fewer cavities, as desired, provided that the cavities are uniformly spaced on the rotor to maintain balance. To provide for perfect leveling of the cavities, the cavities are made with the top and bottom portions of the rotor attached. It is preferred that the cavities be polished.

As shown in FIGS. 7A and 7B, mobile weights (which may be made of steel or other metal) are substantially rectangular. The width 64a of the moveable weights 64 is essentially equal to the width of the cavities 49. When the gear is at rest, the weight is at a minimum distance from the center of rotation. This will provide a minimal or small starting load for the starter motor 18. As rotor 22 begins to spin, the mobile weights move to the outer periphery of the rotor, increasing the speed of the rotor, thereby providing increased rotation of the internal components of generator 20 and turning the shaft of the generator to provide electrical energy.

At the time of assembly of rotor 22, weights 64 are placed in cavities 49. In one embodiment, the weights may include slides 67 to facilitate movement of the mobile weights within the cavities. The surfaces 67a of slides 67 may, optionally, be treated or covered with plastic or other material. When the top and bottom portions of rotor 22 are brought together, slides 67 of mobile weights are located within the gap or raceway 60 formed by the portions of the rotor. In another embodiment, weights 64 may include rollers instead of slides. It is preferred that the sides 69 of the weights 64, which contact the sides of the cavities 49, be polished.

Also, as shown in FIG. 4, raceway 60 may be slightly angled. In a preferred embodiment, the difference in the raceway width at the central portion of the rotor and the more peripheral portion is on the order of approximately 3°. The slight angle facilitates return of the mobile weights to their starting positions (i.e., near the center of rotation) as the rotational speed of the rotor decreases.

The double ball bearing assembly 34 is shown in FIG. 8 in partial cross-section. The assembly includes a left portion 63, and the other has a right portion 65 The two portions of the assembly are joined by a connecting piece 66. The length of connecting piece 65 may be varied to improve the ability of the system to compensate for movement of the vehicle over uneven surfaces. This assembly also allows for easier servicing and adjustments.

One end of the double bearing assembly 34 is attached to columnar member 42, and more specifically to shaft 38 disposed within columnar member 42. Shaft 38 is fitted with spring 74 to allow for limited side-to-side movement of shaft 38 and, consequently, double bearing assembly 34. Spherical bearing 78 also allows for limited vertical (up and down) movement of shaft 38. Spherical bearings may be made of steel, plastic or any other suitable material, as will be appreciated by those of skill in the art.

The outer columnar member 42 is attached at flange 82 to the interior of vehicle body 10, as shown in FIG. 2. The combination of double bearing assembly 34 and moveable shaft 38 allows for limited up and down, side-to-side and angular movement of the assembly, as shown by the directional arrows in FIG. 3. Thus, when vehicle 10 moves over uneven or graded surfaces, this combination compensates for any changes in surface contour while maintaining the generator and rotor in a substantially horizontal position. This also maintains stability of the vehicle 10.

The shaft 9 for attachment to the vehicle body is shown in FIG. 9. As shown in FIG. 9, the shaft has the ability to move horizontally, whereby the spring recoils to its initial position. Also, shaft 38 may move in a limited vertical position, allowing the angle to change. The body of the columnar member 42 is attached to the automobile body. The nut 90 keeps the spring in place and an end ring 94 holds the bearing 78.

In a preferred embodiment, spare car batteries may be maintained in a cassette used in the free space which would have held the fuel tank, as well as part of the trunk area. The assembled cassettes may be stored therein. The cassette may be removable. Service stations will have spare cassette storage, as well as a charging station.

The present invention has been described in connection with its preferred embodiments. It will be understood that the present invention may also be embodied in other forms without departing from the spirit or characteristics of the invention. The above description is intended to be illustrative and non-restrictive, and the invention is not limited to the above-description, but is set forth in the appended claims.

That which is claimed:

1. An energy providing system for an electric vehicle, said system comprising:
a generator for providing electrical energy;
a rotor coupled to said generator;
a starter motor for initiating rotation of said rotor.

2. The system of claim 1 wherein said rotor is rotatably mounted on said generator.

3. The system of claim 1 wherein said rotor comprises a first portion and a second portion mounted thereto, said first and second portions defining multiple cavities in said rotor.

4. The system of claim 3 wherein said cavities are radially disposed about the center of said rotor.

5. The electric vehicle of claim 4 wherein said rotor comprises six cavities.

6. The system of claim 4 further comprising mobile weights housed within said cavities.

7. The system of claim 6 wherein said weights are adapted for movement from one end of said cavity to the opposite end of said cavity.

8. The system of claim 7 wherein said weights include rollers to allow for movement within said cavity.

9. The system of claim 1 comprising a vehicle having a body with an exterior and an interior wherein said generator, rotor and starter motor are attached to said interior of said body.

10. The system of claim 9 further comprising a supporting framework, said framework providing attachment of said rotor, said generator and said starter motor to said body interior.

11. The system of claim 10 comprising means for maintaining said rotor in a substantially horizontal position relative to changes in the angle of the vehicle body.

12. The system of claim 11 wherein said maintaining means comprises a double bearing assembly attached to said framework.
